(19) United States
(12) Patent Application Publication
(10) Pub. No.: US 2022/0224511 A1
(43) Pub. Date: Jul. 14, 2022

(54) CIPHER AND AUTHENTICATION TECHNOLOGIES

(71) Applicant: Intel Corporation, Santa Clara, CA (US)

(72) Inventors: Kamila LIPINSKA, Pepowo (PL); Tomasz KANTECKI, Ennis (IE); Marcel CORNU, Ennis (IE); Pablo DE LARA GUARCH, Shannon (IE); Stephen MCINTYRE, Tullamore (IE); Krystian MATUSIEWICZ, Gdansk (PL); James GUILFORD, Northborough, MA (US); Vinodh GOPAL, Westborough, MA (US); Wajdi FEGHALI, Boston, MA (US)

(21) Appl. No.: 17/710,012

(22) Filed: Mar. 31, 2022

(51) Int. Cl. H04L 9/06; H04L 9/08; G06F 9/30

(52) U.S. Cl. CPC H04L 9/0631; G06F 9/30029; H04L 9/0866; H04L 9/0825

(57) ABSTRACT

Examples described herein relate to executing, on at least one processor, at least one Advanced Encryption Standard (AES) instruction, having an operation code (opcode), on operands, wherein execution of the at least one AES instruction generates an S1 box and/or S2 box of initialization and keystream generation for a SNOW3 cipher operation.

### BACKGROUND

SNOW3G is an cipher scheme used at least in mobile device technology to encrypt and decrypt data. SNOW3G cipher and authentication are part of 3rd Generation Partnership Project (3GPP) standard for Radio Access Network (RAN) for 3G, 4G, and 5G wireless transmission. An example of SNOW3G cipher and authentication is described in European Telecommunications Standards Institute (ETSI) Technical Committee (TC) Security Algorithms Group of Experts (SAGE) Specification: “Specification of the 3GPP Confidentiality and Integrity Algorithms UEA2 and UIA2; Document 2: SNOW 3G specification” version 1.1 (2006) (hereinafter “SNOW3G Specification”).

### BRIEF DESCRIPTION OF THE DRAWINGS

FIG. 1A depicts an example operation of SNOW 3G during key initialization.

FIG. 1B depicts an example operation of SNOW 3G during keystream generation.

FIG. 2A depicts an example of calculation of SNOW3G-UEA2 S1 box.

FIG. 2B depicts an example of calculation of SNOW3G-UEA2 S2 box.

FIG. 3 depicts an example of ShiftRows and reverse of ShiftRows data transformations.

FIG. 4 depicts an example initialization and keystream generation process.

FIG. 5 depicts an example flow diagram of initialization and keystream generation process.

FIG. 6A depicts an example of authentication.

FIG. 6B depicts an example operation of a EVAL_M function.

FIG. 7 depicts an example process.

FIG. 8 depicts an example code segment.

FIG. 9 depicts a system.

FIG. 10 depicts a system.

### DETAILED DESCRIPTION

Cloud and datacenter processors execute virtualized network services such as Virtual Network Functions (VNFs) that perform SNOW3G cipher and authentication operations. Dedicated hardware accelerators can be configured to perform SNOW3G cipher and authentication operations, however, in some cases, use of hardware accelerators to perform SNOW3G cipher and authentication operations can increase a cost of deploying SNOW3G and increase total cost of ownership (TCO) of a platform.

Advanced Encryption Standard (AES) from Federal Information Processing Standards Publication (FIPS) 197 (2001) describes a manner to perform data encryption and decryption. The AES instruction set is available for execution by processors to perform encryption and decryption based on AES. The AESENC instruction performs a single round of an AES encryption flow using a round key from a second source operand, operating on 128-bit data from a first source operand, and stores the result in the destination operand. The AESENCLAST instruction performs a last round of an AES encryption flow using a round key from the second source operand, operating on 128-bit data (state) from the first source operand, and stores the result in the destination operand. Execution of PCLMULQDQ instruction performs carry-less multiplication of two 64-bit operands. For example descriptions of AESENC, AESENCLAST, and PCLMULQDQ see Intel® 64 and IA-32 Architectures Software Developer's Manual (2019), as well as earlier versions, later versions, and derivatives thereof.

SNOW3G cipher and authentication processes can be executed on processors by a combination of AESENC and AESENCLAST instructions and additional operations. SNOW3G cipher and authentication include generating outputs from S1 and S2 boxes. For example, SNOW3G cipher (e.g., UEA2) and authentication (e.g., UIA2) can be performed by a combination of AESENC and AESENCLAST instructions and correction to generate outputs from an S1 box and parallel lookups for generation of outputs from an S2 box. While examples are described with respect to Intel® architecture instructions, instructions executable on other processors, including graphics processing units (GPUs), can be utilized. For example, where ARM-based processors are utilized, ARM AESE (AES single round encryption) and AESMC (AES mix columns) can be performed to calculate S1 and S2 boxes.

For example, an operation code (opcode) can indicate that an AESENC instruction is to be executed. For example, execution of an AESENC instruction can perform a single round of an AES encryption flow using a round key from a second source operand, operating on 128-bit data (e.g., state) from a first source operand and store the result in the destination operand.

For example, an opcode can indicate that an AESENCLAST instruction is to be executed. For example, execution of an AESENCLAST instruction can perform a last round of an AES encryption flow using a round key from a second source operand, operating on 128-bit data (e.g., state) from a first source operand, and store the result in the destination operand.

For example, an opcode can indicate that a PCLMULQDQ instruction is to be executed. For example, execution of PCLMULQDQ instruction can perform a carry-less multiplication of two quadwords, selected from a first source and second source operand according to a value of an immediate byte, where bits 4 and 0 are used to select which 64-bit half of each operand to use.

Other instructions described herein can be identified by opcodes.

VNFs can deploy SNOW3G cipher and authentication based on processor execution of AESENC and AESENCLAST instructions and additional operations. SNOW3G cipher and authentication capabilities can be scaled up or down by respectively increasing or decreasing a number of cores that execute AESENC and AESENCLAST instructions and additional operations. In some examples, SNOW3G cipher and authentication can be performed by accelerator devices (e.g., FPGAs or ASICs) configured based on instructions, operations, and code segments described herein.

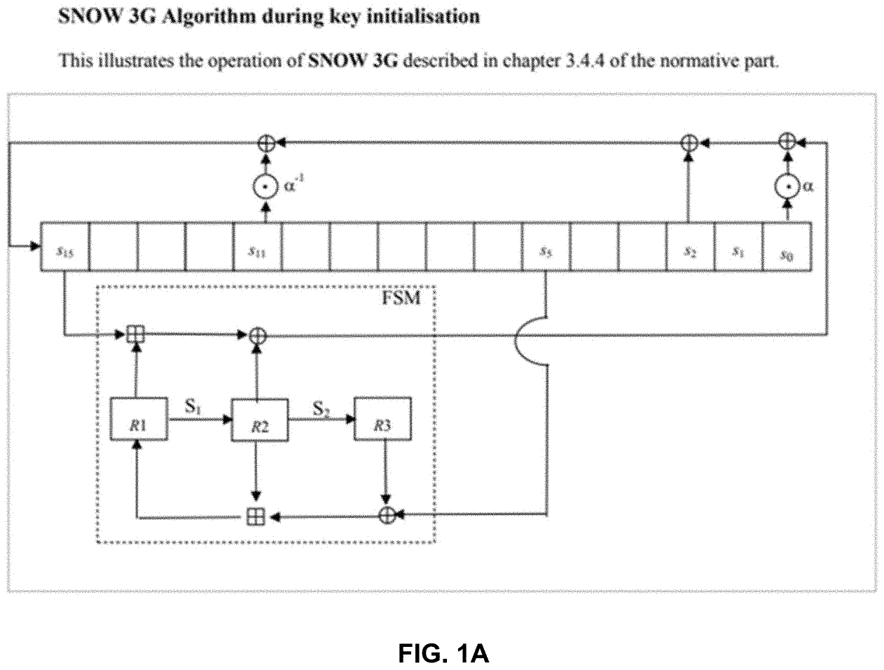

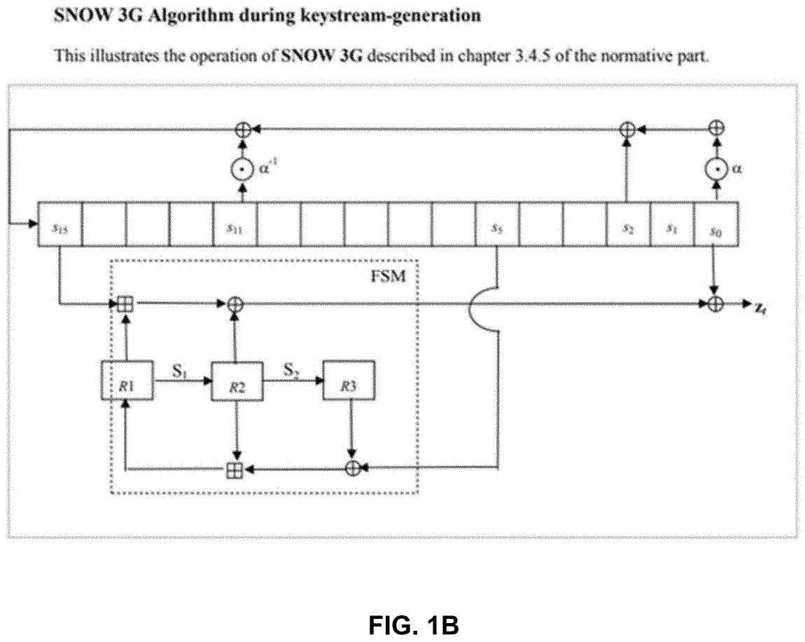

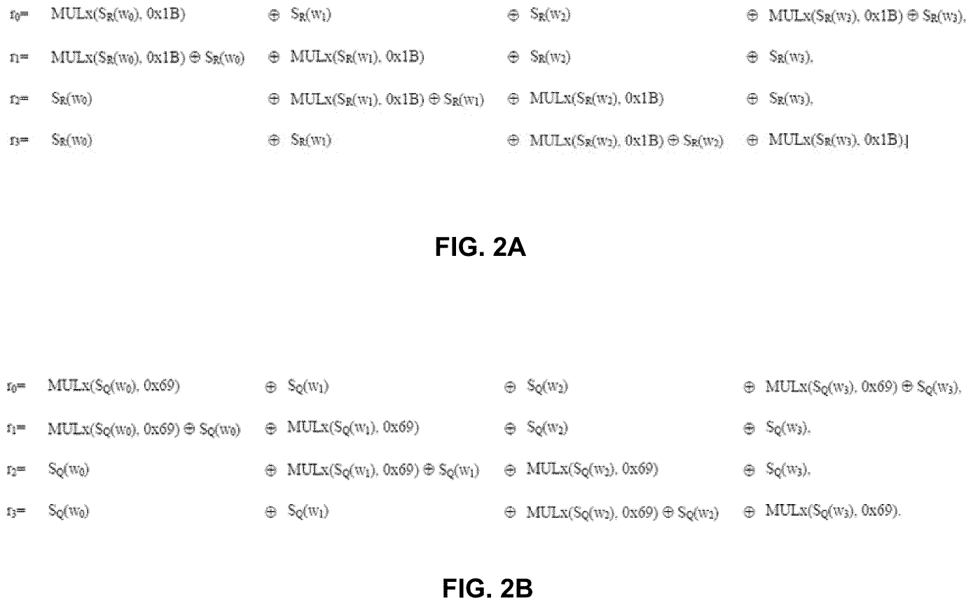

FIG. 1A depicts an example operation of SNOW 3G during key initialization and FIG. 1B depicts an example operation of SNOW 3G during keystream generation. As defined in section 3.3.1 of SNOW3G Specification, FIG. 2A depicts an example of calculation of SNOW3G-UEA2 S1 box. The S1 box calculation can perform mapping of 32 bits to 32 bits. S_{R}(x) can be a byte substitution operation that maps 1 byte to 1 byte according to an Rijndael S-box.

As defined in section 3.3.2 of SNOW3G Specification, FIG. 2B depicts an example of calculation of SNOW3G-UEA2 S2 box. The S2 box calculation performs mapping of 32 bits to 32 bits.

Description turns next to manners of operations to adjust operations to provide an output consistent with SNOW3G S1 or S2 boxes based on AESNI instructions. Execution AESENC instruction performs operations of ShiftRows, SubBytes, MixColumns, and XOR with RoundKey. AESENC operates on 128 bit registers and can process 4 Sbox operations at the same or overlapping time. Execution of AESENCLAST instruction performs operations of ShiftRows, SubBytes, and XOR with RoundKey. AESENCLAST operates on 128 bit registers and can process 4 Sbox operations at the same or overlapping time. Operations and code segments described herein can be performed alone or in combination with other operations and contribute to performance of SNOW3G cipher and authentication operations.

In some cases, SNOW3G operations operate on a single double word at a time. By execution of Intel® Streaming Single Instruction, Multiple Data (SIMD) Extensions (SSE), Advanced Vector Extensions (AVX), or AVX-512 instructions, respective 4, 8, or 16 double words of content (e.g., STATE of FSM registers or LFSR values, keystream words) can be read from memory and processed in parallel. During processing a buffer, a STATE can be maintained, described by fields with FSM values (FSM_1, FSM_2, FSM_3) and 16 LFSR values (LFSR_0 to LFSR_15). FSM and LFSR values can be double word (DW) size. Execution of AESENC and AESENCLAST can process these fields.

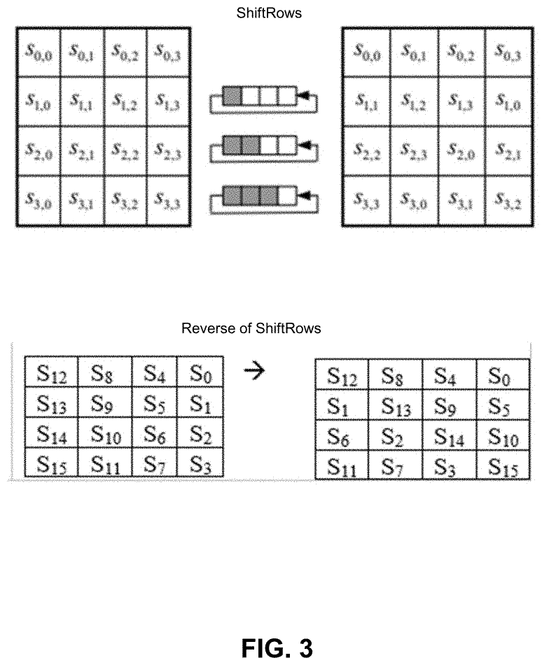

FIG. 3 depicts an example of ShiftRows and reverse of ShiftRows data transformations. However, performance of S1 and S2 boxes does not utilize ShiftRows. Accordingly, a Reverse of ShiftRows or shuffle_mask operation can be performed before passing state for processing by an AESENC operation.

For the S2 box calculation, SubBytes operation can perform a 16-byte transformation defined by applying the S_{R}-Box (e.g., Rijndael S-box). However, in some cases, SNOW3G S2 box applies a different S-box than S_{R}-Box. In such cases, a lookup table (S_{NEW}(x)) can be used to transform inputs to an S-box so that S_{R}(S_{NEW}(x))=S_{Q}(x).

For the S2 box calculation, MixColumns can perform a matrix operation and if multiplied numbers are greater than 8 bits in size, certain fields are XORed with 0x1B. However, for the SNOW3G S2 box calculation, if the product of multiplied numbers is greater than 8 bits in size, the result is XORed with 0x69. Accordingly, operations can be performed whereby if multiplied numbers are greater than 8 bits in size, certain fields are XORed with 0x72 (e.g., 0x69 XOR 0x1B).

For SNOW3G S1 and S2 box calculations, XOR RoundKey is not used and RoundKey can be set to zero so that XOR output does not depend on RoundKey.

Note that operations described herein can be performed for S1 box, S2 box, or S1 and S2 boxes.

Description turns next to parallel calculations in SNOW3G S1 or S2 boxes on multiple buffers. The following code is an example of S1 box calculation (e.g., 32 bit to 32 bit transformation) using 4 buffers, where calculations can occur substantially in parallel.

(xmm) w = 0x0f0302000f0302000f0302000f030200 // w is 4 buffers
appended together. In this example, w includes a concatenation of
FSM_1 registers
(xmm) shuffle_mask = 0x0306090c0f0205080b0e0104070a0d00 // fixed
value to reverse ShiftRows pail of AESENC
(xmm)zero = 0x0
w = shufflebytes (w, shuffle_mask) : pshufb w, shuffle_mask //fix for S1
w = aesenc(w,0): aesenc w, zero
// example w = 0x45787652457876524578765245787652

An S2 box can access a precomputed mapping table. For example, to generate the mapping table, the following can be performed: a parallel lookup of 64 indexes in a 256 elements table of 8-bit values, look-up table inverse Rijndael AES SBox applied on top of Dickson polynomial transform S_{Q}, and execution of an AESENC instruction.

The following code is an example of S2 box calculation (e.g., 32 bit to 32 bit transformation) using 4 buffers, where calculations can occur substantially in parallel.

(xmm) w = 0x0f0302000f0302000f0302000f030200 // w is 4 buffers
appended together. In this example, w includes a concatenation of FSM_2
registers
(xmm) shuffle_mask = 0x0306090c0f0205080b0e0104070a0d00 // fixed
value to reverse ShiftRows part of AESENC
(xmm)zero = 0x0
(apply S_new table for each byte in w) : new_w = LOOKUP(w, S_new
table)
(shuffle bytes in new_w): pshufb new_w, shuffle_mask
(xmm) new_w_copy = new_w
new_w = aesenc(w,0): aesenc new_w, zero
// Roundkey value is zero
// fixes mix column operation in AESENC
(new_w_copy = aesenclast (new_w_copy, 0)): aesenclast
new_w_copy, zero
// Roundkey value is zero
// MixColumns XOR with 0x72 follows
(xmm) 2nd_shuffle_mask = 0x0c0f0e0d080b0a090407060500030201
(xmm) bit_mask = 0x72727272727272727272727272727272
(xmm) temp_pattern = 0
(for each byte check if ms bit is set - if yes replace byte with
0xff -signed compare operation is used):
pcmpgtb temp_pattern, new_w_copy
(xmm) pattern_shuf = temp_pattern
pshufb pattern_shuf , 2nd_shuffle_mask
pxor pattern, pattern_shuf
pand pattern, bit_mask
pxor new_w, pattern
new_w = 0xA4B19C63A4B19C63A4B19C63A4B19C63 // Example
output of w

As part of a Clock LFSR operation of SNOW3G for applying a S2 inverse-S_{R}(S_{Q}(Wi)), MulAlpha table or DivAlpha table, lookup operations can perform different parallel lookups. Parallel constant time lookups can be performed to lookup S2 on inverse-S_{R}(S_{Q}(Wi)), α and α⁻¹ shown in FIGS. 1A and 1B using execution of Intel® AVX512 and VBMI extensions.

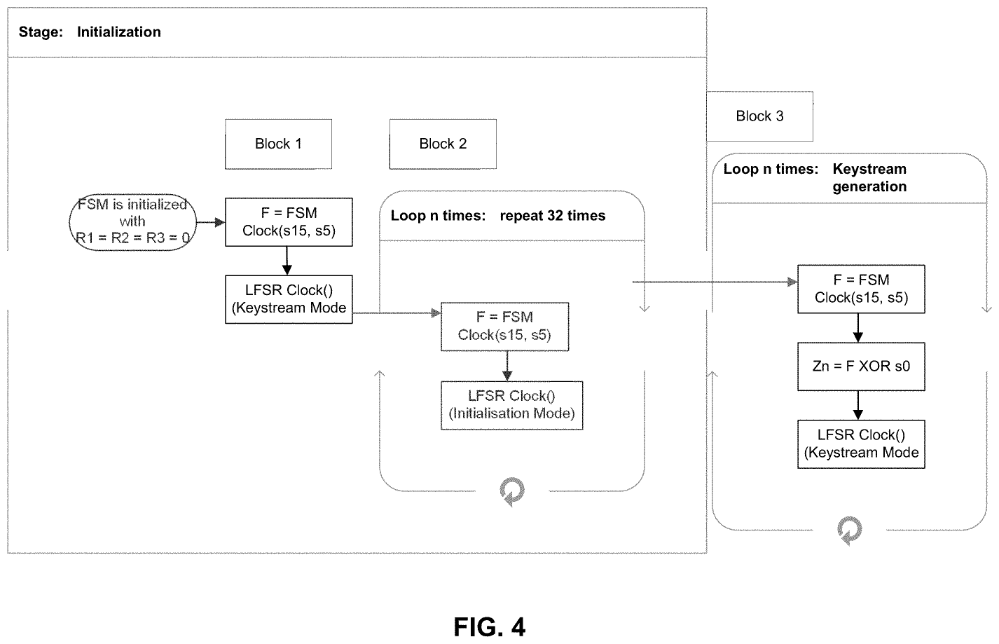

FIG. 4 depicts an example initialization and keystream generation process. Block 1 and block 2 can be performed during an initialization operation. Performance of blocks 1 and 2 can execute code segments F=FSM clocks (s15, s5) and LFSR Clock( ). s15 can represent LFSR register 15 and s5 can represent LFSR register 5. Similarly, block 3 can use code F=FSM clocks (s15, s5) and LFSR Clock( ). As shown, block 2 can include repeating execution of code segments F=FSM clocks (s15, s5) and LFSR Clock( ) 32 times whereas block 3 can include repeating execution of code segments F=FSM clocks (s15, s5), Zn=F XOR s0, and LFSR Clock( ) n number of times. In block 3, Zn=F XOR s0 can be performed, s0 represents LFSR register 0. For example, as described in SNOW3G Specification, section 3.4.6 (Clocking the FSM), FSM clock( ) involves calculation of S1 and S2. For example, to perform section 3.4.1 (Clocking the LFSR) described in SNOW3G Specification, LFSR Clock( ) can perform parallel alpha transform lookup operations. A single mask can be used to XOR F in LFSR Clock (set for init mode) and a second mask can be used to control keyword calculation (Zₙ).

LFSR clock( ) in initialization mode and keystream generation can differ in calculating s15=v. In initialization mode, v=(s0,1∥s0,2∥s0,3∥0x00) ⊕ MULα(s0,0) ⊕ s2 ⊕ (0x00∥s11,0∥s11,1∥s11,2) ⊕ DIVα(s11,3) ⊕ F, where F is an output of FSM clock. In keystream generation, v=(s0,1∥s0,2∥s0,3∥0x00) ⊕ MULα(s0,0) ⊕ s2 ⊕ (0x00∥s11,0∥s11,1∥s11,2) ⊕ DIVα(s11,3).

In a keystream generation, 32 bits of keystream can be generated. Some vector instructions support up to 512 bits of data that can be processed in single instruction (e.g., 128 bits for SSE, 256 bits for AVX, or 512 bits for AVX512). Executing the same code can process up to 16 different buffers (512:32). If the same code with proper masks is used for buffers in different initialization and keystream generation phases, those vector instructions can be used to increase usage of SIMD instructions to reduce time to complete keystream generation.

After initialization and keystream generation, encryption of plaintext or other data can occur by keystream XOR with plaintext or data. Ciphertext can be decrypted by XOR of encrypted data with keystream.

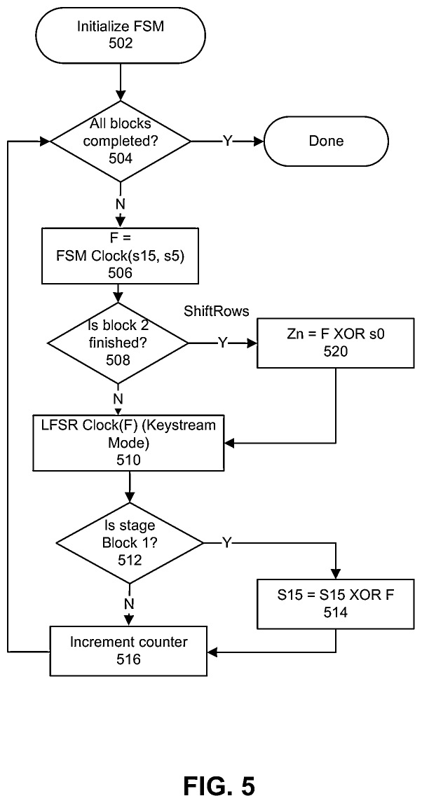

FIG. 5 depicts an example flow diagram of initialization and keystream generation process. At 502, FSM1-FSM3 can be initialized. For example, FSM1-FSM3, and counters can be initialized to values of zero. Counters can refer to a number of times execution of code segments is repeated. In SNOW3G specification, number of times is N. At 504, a determination can be made if blocks 1-3 are completed. If blocks 1-3 are completed, the process can complete. If a block among blocks 1-3 is not completed, the process can continue to 506. At 506, a determination of F=FSM clocks (s15, s5) can be performed.

At 508, a determination can be made if block 2 is completed. If block 2 is not completed, the process can continue to 510. At 510, calculation of LFSR Clock( ) in keystream generation mode can take place. If block 2 is completed, the process can continue to 520.

At 512, a determination can be made if block 1 is currently executing. If block 1 is currently executing, the process can continue to 514. If block 1 is not currently executing, the process can continue to 516.

At 514, performance of S15 XOR F can take place to generate keystream. In some examples, F=FSM clocks (s15, s5). At 516, a counter of iterations of code execution can be incremented.

At 520, performance of Zn=F XOR s0 can take place and 510 can follow 520. Note that register with mask value can be applied and a single SIMD instruction in 514 or 520 could take effect for some of the packed data relating to buffers indicated in a mask.

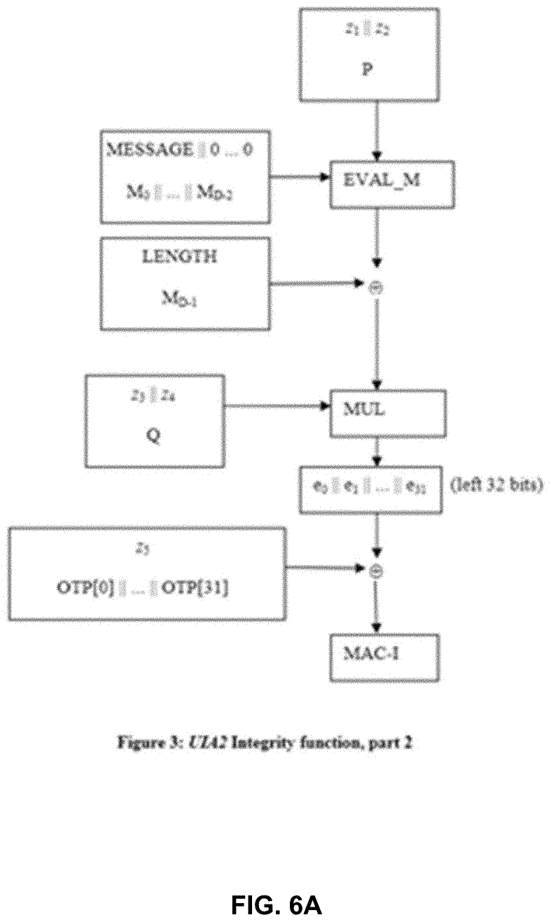

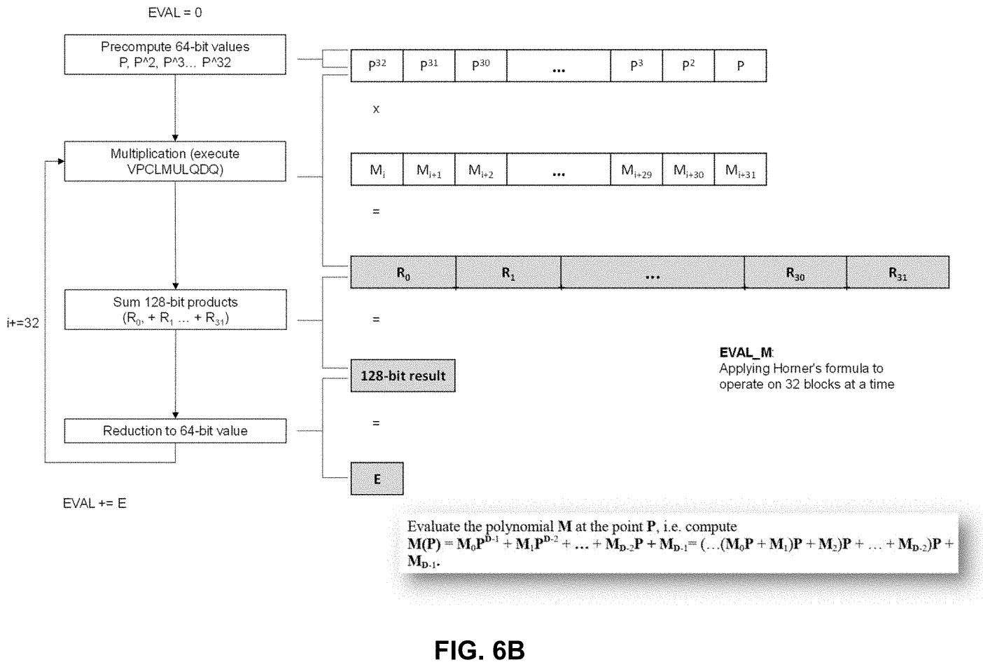

FIG. 6A depicts an example of authentication using 5 generated keystream words for UIA2 Integrity function, part 2 from FIG. 3 of SNOW3G Specification. Examples of authentication are described with respect to ETSI/SAGE Specification, “Specification of the 3GPP Confidentiality and Integrity Algorithms UEA2 & UIA2,” Version 2.1 (March 2009). For example, sections 1.1 and 1.2 of SNOW3G Specification describe an example of authentication operations. Authentication can add an integrity check to a payload, apart from encryption. For example, to perform authentication, 5 keystreams words can be generated for buffers in parallel (e.g., Z1-Z5 in FIG. 6A) using a multi-buffer process as performed for encryption; constants P1-P32 used for Homer's formula can be pre-computed to operate on 32 blocks at a time; and single-buffer processing of the message can be applied using Homer's method to operate on 32 blocks at a time.

In some examples, to perform authentication, carryless multiply using Intel® PCLMULQDQ instruction can be performed followed by a reduction. Horner's formula can be applied to process multiple blocks in parallel, and/or hashing constants can be generated in parallel for multiple buffers followed by hashing the message in single buffer manner. For example, hashing constants can include 5 keystream words.

The UIA2 algorithm is primarily made up of functions MUL( ) and EVAL_M( ). The function MUL( ) maps 192 bits to 64 bits and is the basis of the EVAL_M( ) function. The function MUL( ) computes V×P in mod 2 arithmetic and the product is reduced by c (e.g., the irreducible polynomial x⁶⁴+x⁴+x³+x+1). Execution of the PCLMULQDQ instruction can be used to improve the efficiency of both the multiplication and the reduction of the MUL( ) operation.

The EVAL_M function operation depends on 64-bit values D, Z, and P. EVAL_M can also be represented with the polynomial M of degree D-1 in GF(2⁶⁴)[X]. By precomputing N constants from P to Pⁿ and applying Homer's formula to perform EVAL_M( ), multiple independent Carry-Less Multiplication operations (e.g., on 32 blocks at a time) can be performed followed by a single reduction to evaluate M. In other words, for a message 64 blocks in length, instead of doing 64 multiplies and 64 reductions, 2 multiplies (×32 blocks) and 2 reductions can be performed. For example, FIG. 6B depicts an example of performing EVAL_M( ) for 32 blocks at a time.

Operation (V×P) may result in a product larger than 64-bits. The irreducible polynomial (0x1b) is used to map the result to a 64-bit value. A 2-stage folding reduction technique by execution of PCLMULQDQ and XOR operations can be performed to ensure the correct 64-bit result.

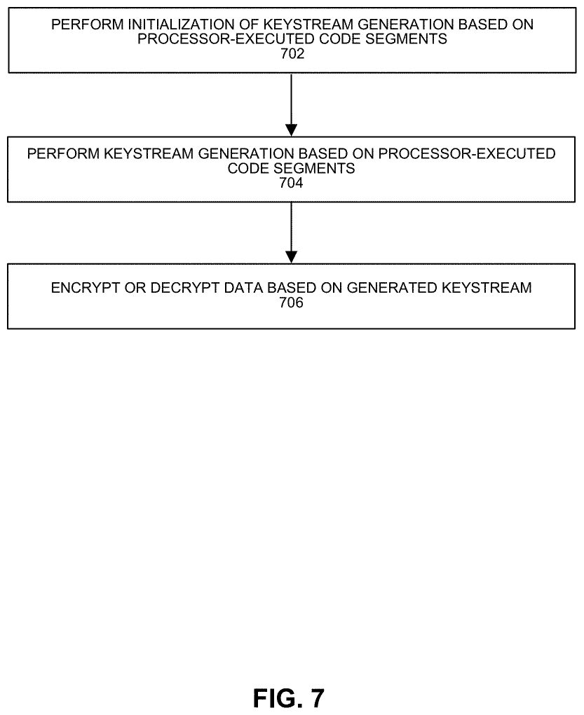

FIG. 7 depicts an example process. The process can be performed by one or more processors that execute code segments. At 702, initialization for keystream generation can be performed. In some examples, code segments to perform F=FSM clocks (s15, s5) and LFSR Clock( ) can be repeatedly executed in block 1 and block 2 of initialization for keystream generation. In some examples, FSM clock( ) involves calculation of S1 and S2 and in connection with S1 and S2 box calculations, AESENC and AESENCLAST can be executed. In some examples, 4, 8, or 16 double words of state or keystream can be read from memory and processed in parallel.

At 704, keystream generation can be performed. In some examples, code segments to perform F=FSM clocks (s15, s5), Zn=F XOR s0, and LFSR Clock( ) can be repeatedly executed in block 3 of keystream generation. In some examples, FSM clock( ) involves calculation of S1 and S2 and in connection with S1 and S2 box calculations, AESENC and AESENCLAST can be executed. In some examples, 4, 8, or 16 double words of state or keystream can be read from memory and processed in parallel.

At 706, perform data encryption or decryption based on generated keystream. For example, after initialization and keystream generation, encryption of plaintext or other data can occur by generated keystream XOR with plaintext or data. For example, after initialization and keystream generation, decryption of data can occur by XOR of encrypted data with generated keystream. Encrypted data can be stored to memory or transmitted using a network interface device to a receiver. Decrypted data can be stored to memory and processed by a VNF or other process.

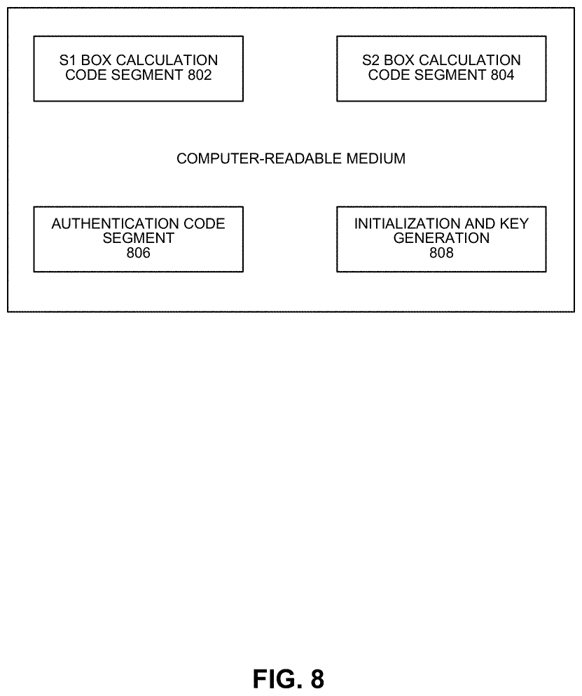

FIG. 8 depicts an example computer-readable medium. S1 box calculation code segment 802 can include one or more of: at least one AESENC instruction, shuffle_mask operation to pack data words from buffers into a single SIMD operation, reused code segments, as described herein. S1 box calculation code segment 802 can include instructions to pack 32-bit data words as input to single AESENC instruction for S1 with shuffle_mask operation performed before performance of AESENC instruction.

S2 box calculation code segment 804 can include one or more of: at least one AESENC instruction, at least one AESENCLAST instruction, shuffle_mask operation to pack data words from buffers into a single SIMD operation, correction code segments, parallel data fetching segments, reused code segments, as described herein.

S1 box calculation code segment 802 and S2 box calculation code segment 804 can be executed by one or more processors in connection with encryption or decryption of data based on SNOW3G.

Authentication code segment 806 can include one or more of: PCLMULQDQ instruction and reduction code segments. Authentication code segment 806 can executed by one or more processors in connection with an operation authentication based on SNOW3G.

Code segment 808, when executed, can perform initialization and key generation for encryption or decryption.

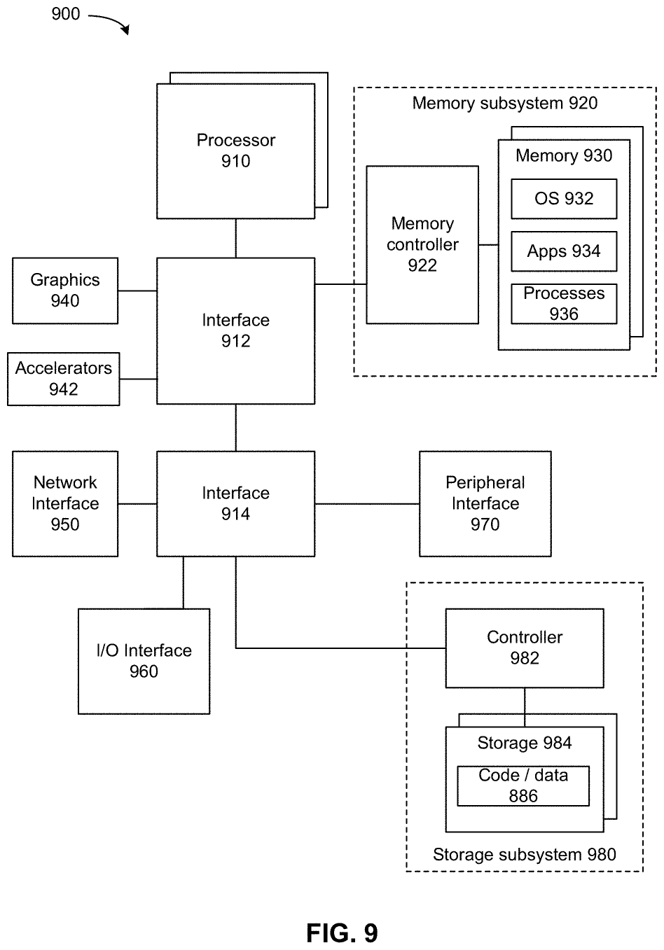

FIG. 9 depicts an example computing system. Components of system 900 (e.g., processor 910, network interface 950, and so forth) can be configured to perform encryption or decryption of data based on SNOW3G, as described herein. System 900 includes processor 910, which provides processing, operation management, and execution of instructions for system 900. Processor 910 can include any type of microprocessor, central processing unit (CPU), graphics processing unit (GPU), processing core, or other processing hardware to provide processing for system 900, or a combination of processors. Processor 910 controls the overall operation of system 900, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 900 includes interface 912 coupled to processor 910, which can represent a higher speed interface or a high throughput interface for system components that needs higher bandwidth connections, such as memory subsystem 920 or graphics interface components 940, or accelerators 942. Interface 912 represents an interface circuit, which can be a standalone component or integrated onto a processor die. Where present, graphics interface 940 interfaces to graphics components for providing a visual display to a user of system 900. In one example, graphics interface 940 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 940 generates a display based on data stored in memory 930 or based on operations executed by processor 910 or both. In one example, graphics interface 940 generates a display based on data stored in memory 930 or based on operations executed by processor 910 or both.

Accelerators 942 can be a fixed function or programmable offload engine that can be accessed or used by a processor 910. For example, an accelerator among accelerators 942 can provide compression (DC) capability, cryptography services such as public key encryption (PKE), cipher, hash/authentication capabilities, decryption, or other capabilities or services. In some embodiments, in addition or alternatively, an accelerator among accelerators 942 provides field select controller capabilities as described herein. In some cases, accelerators 942 can be integrated into a CPU socket (e.g., a connector to a motherboard or circuit board that includes a CPU and provides an electrical interface with the CPU). For example, accelerators 942 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 942 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 920 represents the main memory of system 900 and provides storage for code to be executed by processor 910, or data values to be used in executing a routine. Memory subsystem 920 can include one or more memory devices 930 such as read-only memory (ROM), flash memory, one or more varieties of random access memory (RAM) such as DRAM, or other memory devices, or a combination of such devices. Memory 930 stores and hosts, among other things, operating system (OS) 932 to provide a software platform for execution of instructions in system 900. Additionally, applications 934 can execute on the software platform of OS 932 from memory 930. Applications 934 represent programs that have their own operational logic to perform execution of one or more functions. Processes 936 represent agents or routines that provide auxiliary functions to OS 932 or one or more applications 934 or a combination. OS 932, applications 934, and processes 936 provide software logic to provide functions for system 900. In one example, memory subsystem 920 includes memory controller 922, which is a memory controller to generate and issue commands to memory 930. It will be understood that memory controller 922 could be a physical part of processor 910 or a physical part of interface 912. For example, memory controller 922 can be an integrated memory controller, integrated onto a circuit with processor 910.

Applications 934 can perform packet processing based on one or more of Data Plane Development Kit (DPDK), Storage Performance Development Kit (SPDK), OpenDataPlane, Network Function Virtualization (NFV), software-defined networking (SDN), Evolved Packet Core (EPC), or 5G network slicing. Some example implementations of NFV are described in ETSI specifications or Open Source NFV MANO from ETSI's Open Source Mano (OSM) group. A virtual network function (VNF) can include a service chain or sequence of virtualized tasks executed on generic configurable hardware such as firewalls, domain name system (DNS), caching or network address translation (NAT) and can run in VEEs. VNFs can be linked together as a service chain. In some examples, EPC is a 3GPP-specified core architecture at least for Long Term Evolution (LTE) access. 5G network slicing can provide for multiplexing of virtualized and independent logical networks on the same physical network infrastructure. Some applications can perform video processing or media transcoding (e.g., changing the encoding of audio, image or video files). In some examples, a VNF can cause performance of initialization phase (e.g., initialization of state of LFSRs and FSMs), keystream generation, and/or authentication for a SNOW3 cipher operation as described herein.

In some examples, OS 932 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Broadcom®, NVIDIA®, Qualcomm®, IBM®, Texas Instruments®, among others.

While not specifically illustrated, it will be understood that system 900 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 900 includes interface 914, which can be coupled to interface 912. In one example, interface 914 represents an interface circuit, which can include standalone components and integrated circuitry. In one example, multiple user interface components or peripheral components, or both, couple to interface 914. Network interface 950 provides system 900 the ability to communicate with remote devices (e.g., servers or other computing devices) over one or more networks. Network interface 950 can include an Ethernet adapter, wireless interconnection components, cellular network interconnection components, USB (universal serial bus), or other wired or wireless standards-based or proprietary interfaces. Network interface 950 can transmit data to a device that is in the same data center or rack or a remote device, which can include sending data stored in memory. Network interface 950 (e.g., packet processing device) can execute a virtual switch to provide virtual machine-to-virtual machine communications for virtual machines (or other VEEs) in a same server or among different servers.

Some examples of network interface 950 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 950 can include a programmable processing pipeline that is programmable by P4, C, Python, Broadcom Network Programming Language (NPL), NVIDIA® CUDA®, NVIDIA® DOCA™, or x86 compatible executable binaries or other executable binaries. A programmable processing pipeline can include one or more match-action units (MAUs) that can schedule packets for transmission using one or multiple granularity lists, as described herein. Processors, FPGAs, other specialized processors, controllers, devices, and/or circuits can be used utilized for packet processing or packet modification. Ternary content-addressable memory (TCAM) can be used for parallel match-action or look-up operations on packet header content. Programmable pipeline can be configured to perform encryption or decryption of data based on SNOW3G, as described herein.

In one example, system 900 includes one or more input/output (I/O) interface(s) 960. I/O interface 960 can include one or more interface components through which a user interacts with system 900 (e.g., audio, alphanumeric, tactile/touch, or other interfacing). Peripheral interface 970 can include any hardware interface not specifically mentioned above. Peripherals refer generally to devices that connect dependently to system 900. A dependent connection is one where system 900 provides the software platform or hardware platform or both on which operation executes, and with which a user interacts.

In one example, system 900 includes storage subsystem 980 to store data in a nonvolatile manner. In one example, in certain system implementations, at least certain components of storage 980 can overlap with components of memory subsystem 920. Storage subsystem 980 includes storage device(s) 984, which can be or include any conventional medium for storing large amounts of data in a nonvolatile manner, such as one or more magnetic, solid state, or optical based disks, or a combination. Storage 984 holds code or instructions and data 986 in a persistent state (e.g., the value is retained despite interruption of power to system 900). Storage 984 can be generically considered to be a “memory,” although memory 930 is typically the executing or operating memory to provide instructions to processor 910. Whereas storage 984 is nonvolatile, memory 930 can include volatile memory (e.g., the value or state of the data is indeterminate if power is interrupted to system 900). In one example, storage subsystem 980 includes controller 982 to interface with storage 984. In one example controller 982 is a physical part of interface 914 or processor 910 or can include circuits or logic in both processor 910 and interface 914.

A volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). Another example of volatile memory includes cache or static random access memory (SRAM).

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, or NVM devices that use chalcogenide phase change material (for example, chalcogenide glass).

A power source (not depicted) provides power to the components of system 900. More specifically, power source typically interfaces to one or multiple power supplies in system 900 to provide power to the components of system 900. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 900 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

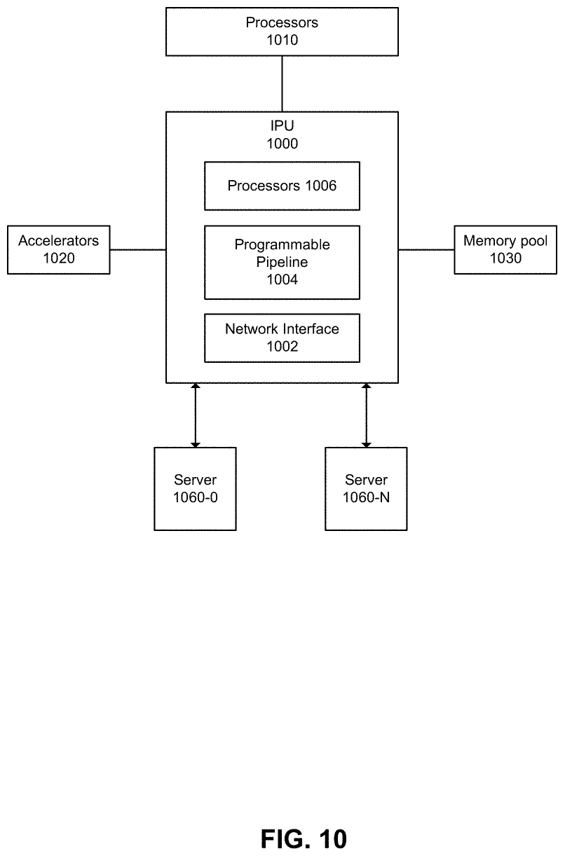

FIG. 10 depicts an example system. In this system, IPU 1000 manages performance of one or more processes using one or more of processors 1006, processors 1010, accelerators 1020, memory pool 1030, or servers 1040-0 to 1040-N, where N is an integer of 1 or more. In some examples, processors 1006 of IPU 1000 can execute one or more processes, applications, VMs, containers, microservices, and so forth that request performance of workloads by one or more of: processors 1010, accelerators 1020, memory pool 1030, and/or servers 1040-0 to 1040-N. IPU 1000 can utilize network interface 1002 or one or more device interfaces to communicate with processors 1010, accelerators 1020, memory pool 1030, and/or servers 1040-0 to 1040-N. IPU 1000 can utilize programmable pipeline 1004 to process packets that are to be transmitted from network interface 1002 or packets received from network interface 1002. Programmable pipeline 1004 and/or processors 1006 can be configured to perform encryption or decryption of data based on SNOW3G, as described herein.

Embodiments herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), on-premises data centers, off-premises data centers, edge network elements, fog network elements, and/or hybrid data centers (e.g., data center that use virtualization, cloud and software-defined networking to deliver application workloads across physical data centers and distributed multi-cloud environments).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes one or more examples, and includes at least one non-transitory computer-readable medium comprising instructions stored thereon, that if executed by one or more processors, cause the one or more processors to: execute at least one Advanced Encryption Standard (AES) instruction, having an operation code (opcode), on operands, wherein execution of the at least one AES instruction is to generate an S1 box and/or S2 box of initialization and keystream generation for a SNOW3 cipher operation.

Example 2 includes one or more examples, wherein the AES instruction comprises first and/or second instructions and wherein execution of the first instruction is to perform a round of an AES encryption flow and execution of the second instruction is to perform a last round of the AES encryption flow.

Example 3 includes one or more examples, wherein execution of the first instruction performs operations of ShiftRows, SubBytes, MixColumns, and XOR with RoundKey.

Example 4 includes one or more examples, wherein perform ShiftRows operation comprises perform a reverse of ShiftRows before passing state for processing by an executed first instruction.

Example 5 includes one or more examples, wherein perform SubBytes operation comprises accessing a lookup table to modify inputs to an S-box.

Example 6 includes one or more examples, wherein perform MixColumns operation comprises: based on multiplied numbers being greater than 8 bits in size, XOR particular fields with 0x72.

Example 7 includes one or more examples, wherein the RoundKey is zero.

Example 8 includes one or more examples, comprises instructions stored thereon, that if executed by one or more processors, cause the one or more processors to: encrypt plaintext based on the generated keystream.

Example 9 includes one or more examples, comprises instructions stored thereon, that if executed by one or more processors, cause the one or more processors to: decrypt plaintext based on the generated keystream.

Example 10 includes one or more examples, and includes a method comprising: executing, on at least one processor, at least one Advanced Encryption Standard (AES) instruction, having an operation code (opcode), on operands, wherein execution of the at least one AES instruction generates an S1 box and/or S2 box of initialization and keystream generation for a SNOW3 cipher operation.

Example 11 includes one or more examples, wherein the AES instruction comprises first and/or second instructions and wherein execution of the first instruction is to perform a round of an AES encryption flow and execution of the second instruction is to perform a last round of the AES encryption flow.

Example 12 includes one or more examples, wherein execution of the first instruction performs operations of ShiftRows, SubBytes, MixColumns, and XOR with RoundKey.

Example 13 includes one or more examples, wherein performing ShiftRows operation comprises performing a reverse of ShiftRows before passing state for processing by an executed AESENC instruction.

Example 14 includes one or more examples, wherein performing SubBytes operation comprises accessing a lookup table to modify inputs to an S-box.

Example 15 includes one or more examples, wherein performing MixColumns operation comprises: based on multiplied numbers being greater than 8 bits in size, XOR particular fields with 0x72.

Example 16 includes one or more examples, wherein the RoundKey is zero.

Example 17 includes one or more examples, and includes encrypting plaintext based on the generated keystream.

Example 18 includes one or more examples, and includes decrypting plaintext based on the generated keystream.

Example 19 includes one or more examples, and includes at least one non-transitory computer-readable medium comprising instructions stored thereon, that if executed by one or more processors, cause the one or more processors to: perform an authentication of a SNOW3 encrypted data based on a carry-less multiplication quadword operation and a reduction operation.

Example 20 includes one or more examples, wherein the carry-less multiplication quadword operation comprises PCLMULQDQ.

What is claimed is:

1. At least one non-transitory computer-readable medium comprising instructions stored thereon, that if executed by one or more processors, cause the one or more processors to:
execute at least one Advanced Encryption Standard (AES) instruction, having an operation code (opcode), on operands, wherein execution of the at least one AES instruction is to generate an S1 box and/or S2 box of initialization and keystream generation for a SNOW3 cipher operation.

2. The at least one computer-readable medium of claim 1, wherein the AES instruction comprises first and/or second instructions and wherein execution of the first instruction is to perform a round of an AES encryption flow and execution of the second instruction is to perform a last round of the AES encryption flow.

3. The at least one computer-readable medium of claim 2, wherein execution of the first instruction performs operations of ShiftRows, SubBytes, MixColumns, and XOR with RoundKey.

4. The at least one computer-readable medium of claim 3, wherein perform ShiftRows operation comprises perform a reverse of ShiftRows before passing state for processing by an executed first instruction.

5. The at least one computer-readable medium of claim 3, wherein perform SubBytes operation comprises accessing a lookup table to modify inputs to an S-box.

6. The at least one computer-readable medium of claim 3, wherein perform MixColumns operation comprises:
based on multiplied numbers being greater than 8 bits in size, XOR particular fields with 0x72.

7. The at least one computer-readable medium of claim 3, wherein the RoundKey is zero.

8. The at least one computer-readable medium of claim 1, comprises instructions stored thereon, that if executed by one or more processors, cause the one or more processors to:
encrypt plaintext based on the generated keystream.

9. The at least one computer-readable medium of claim 1, comprises instructions stored thereon, that if executed by one or more processors, cause the one or more processors to:
decrypt plaintext based on the generated keystream.

10. A method comprising:
executing, on at least one processor, at least one Advanced Encryption Standard (AES) instruction, having an operation code (opcode), on operands, wherein execution of the at least one AES instruction generates an S1 box and/or S2 box of initialization and keystream generation for a SNOW3 cipher operation.

11. The method of claim 10, wherein the AES instruction comprises first and/or second instructions and wherein execution of the first instruction is to perform a round of an AES encryption flow and execution of the second instruction is to perform a last round of the AES encryption flow.

12. The method of claim 11, wherein execution of the first instruction performs operations of ShiftRows, SubBytes, MixColumns, and XOR with RoundKey.

13. The method of claim 12, wherein performing ShiftRows operation comprises performing a reverse of ShiftRows before passing state for processing by an executed AESENC instruction.

14. The method of claim 12, wherein performing SubBytes operation comprises accessing a lookup table to modify inputs to an S-box.

15. The method of claim 12, wherein performing MixColumns operation comprises:
based on multiplied numbers being greater than 8 bits in size, XOR particular fields with 0x72.

16. The method of claim 12, wherein the RoundKey is zero.

17. The method of claim 10, comprising:
encrypting plaintext based on the generated keystream.

18. The method of claim 10, comprising:
decrypting plaintext based on the generated keystream.

19. At least one non-transitory computer-readable medium comprising instructions stored thereon, that if executed by one or more processors, cause the one or more processors to:
perform an authentication of a SNOW3 encrypted data based on a carry-less multiplication quadword operation and a reduction operation.

20. The at least one computer-readable medium of claim 19, wherein the carry-less multiplication quadword operation comprises PCLMULQDQ.
